(19) United States
(12) Patent Application Publication
(10) Pub. No.: US 2006/0048137 A1
(43) Pub. Date: Mar. 2, 2006

(54) Method and apparatus for cloning an ORACLE RDBMS software

(75) Inventors: Mohamed Nosseir, Castro Balley, CA (US); Bharat Paliwal, Foster City, CA (US); Joseph M. Mansur, Tyngsboro, MA (US)

Correspondence Address: PERMAN & GREEN, 425 POST ROAD, FAIRFIELD, CT, 06824, US

(73) Assignee: ORACLE INTERNATIONAL CORPORATION, REDWOOD SHORES, CA (US)

(21) Appl. No.: 10/932,520

(22) Filed: Sep. 2, 2004

(51) Int. Cl. G06F 9/445

(52) U.S. Cl. 717/174

(57) ABSTRACT

A method of cloning a clonable system from a source environment to a target environment. In one embodiment the method comprises storing installation scripts used to install a home in the source environment in the home. The home can be copied to the target environment. The installation scripts stored in the home are also copied to the target environment and located inside the home in the target environment. The installation scripts are then executed in the target environment to complete the cloning of the clonable system in the target environment.

### BACKGROUND OF THE INVENTION

1. Field of the Invention

The present invention relates to database installation and in particular to reconfiguring a database installation to operate or run in an environment that is not the original installation environment.

2. Brief Description of Related Developments

A specific installation of a database, such as for example, an Oracles database, often includes multiple steps other than the basic installation of the database from the shipped media. Some of these steps include applying patchsets, applying one-off patches, and manual tweaking of the software's configuration to enable the installation to operate properly in the home environment.

Administrators often face the task of “copying” a specific installation from the home environment to another or different environment. A “home” environment is generally considered the system context in which a product runs. This could be due to any number of reasons including for example, a hardware upgrade, scaling-up the database to add more capacity, adding a node to a grid or supporting new customers for a hosting service.

Performing the task of copying an installation (an operation referred to herein as “cloning”) has been so far performed by customers each in their own way and generally encompasses some type of reverse engineering. For example, the process can comprise steps such as:
1) Copying the software from the source location to the target location, and
2) Using a combination of scripts and manual tweaking of the configuration files to get the software to work in the new environment or target location.

The above process suffers from a number of problems. For example, the process is error prone since there is no unified and well-documented set of steps to be followed through the copying process. Customers are usually faced with the task of reverse engineering the product in order to get it to work in the new environment. The process may also be incomplete. Some of the components of database installations cannot be simply copied or cloned. The customer will have to skip those components on the target home and “make do” without them. These types of copying processes are also hard to support. Due to the ad-hoc nature of the copying process, attempts to replicate databases tend to generate lots of support calls, to for example, Oracle™ support.

Furthermore, in order to clone a specific product, the customer needs to know many of the internal details of the product. This is required because the customer needs to know which files/parameters need to be updated to fit the software into the new target environment. Add to that the fact that these steps will differ based on variables such as the version of the product, the patchsets applied, and the products installed in a specific home (server only, server and client, server and companion CD), and the process becomes even more complex. Thus, each copying or cloning process is very product, product version and environment specific and labor intensive.

A database home can comprise any number of different components. Each component has its own set of operating logic. The operating logic for each component needs to be configured at the time of the installation to the machine's operating system. A user needs to know exactly what is installed in a database home and how it is configured to be able to clone it.

It would be advantageous to be able to automatically clone a database home without the need to manually reconfigure a copied installation in the new environment in order to apply the needed version updates, patchsets, or other configuration changes or modifications to the database home.

### SUMMARY OF THE INVENTION

The present invention is directed to a method of cloning a system from a source environment to a target environment. In one embodiment the method comprises storing installation scripts used to install a home in the source environment in the home. The home can be copied to the target environment. The installation scripts stored in the home are also copied to the target environment and located inside the home in the target environment. The installation scripts are then executed in the target environment together with any updates or modifications to complete the cloning of the system in the target environment.

In one aspect, the present invention is directed to a method of facilitating adding a node to a computer grid. In one embodiment, the method comprises locating installation scripts from a home copied to at least one target environment. The installation scripts are those original installation scripts used to install the home together with any updates or modifications thereto. The installation scripts are executed inside the target environment to automatically install the home in the target environment.

In another aspect the present invention is directed to a computer program product. In one embodiment the computer program product comprises a computer useable medium having computer readable code means embodied therein for causing a computer to automatically replicate a clonable system in a target environment that is different from a home environment. The computer readable code means in the computer program product comprises computer readable program code means for causing a computer to store original installation scripts used during the installation of the home, and any updates or modifications to the home, in the home environment. The computer readable code means also comprises computer readable program code means for causing a computer to locate the original installations scripts and any updates or modifications in the target environment after the home is copied from the home environment to the target environment. The original installation scripts and any updates or modifications are generally transferred to the target environment when the home is copied to the target environment. The computer readable program code means also comprises computer readable program code means for causing a computer to execute the original installation scripts and any updates or modification in the target environment to complete cloning of the home in the target environment.

In a further aspect the present invention is directed to an article of manufacture. In one embodiment the article of manufacture comprises a computer useable medium having computer readable program code means embodied therein for causing a computer to replicate a clonable system from a home environment in a target environment. The computer readable code means in the article of manufacture comprises computer readable program code means for causing a computer to store, in the home environment, original installation scripts used during the installation of the system, and any updates or modifications to the home, locate in the target environment, the original installations scripts and any updates or modifications. The original installation scripts and any updates or modifications are generally copied from the home environment to the target environment. The computer readable program code means also comprises computer readable program code means for causing a computer to execute in the target environment, the original installation scripts and any updates or modifications to replicate the system in the target environment.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention.

FIG. 2 is a flowchart illustrating one embodiment of a process incorporating features of the present invention.

FIG. 3 is a block diagram of a grid computer configuration in which the present invention may be utilized.

FIG. 4 is a flowchart of one embodiment of a process to add a node in a grid computing system incorporating features of the present invention.

FIG. 5 is a block diagram of one embodiment of an architecture that can be used to practice the present invention.

### DETAILED DESCRIPTION OF THE PREFERRED EMBODIMENT(s)

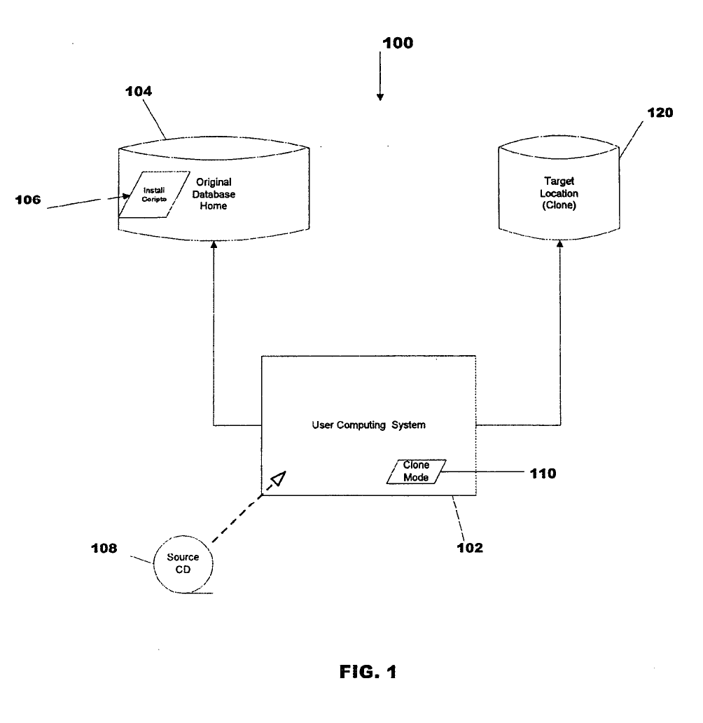

Referring to FIG. 1, a schematic diagram of a system 100 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

The present invention makes cloning, or the ability to copy a software or program installation or application, from a source environment to a target environment, an integral part of the original installation process of the application. Generally, the installation scripts, code directly executable by a program that understands the language in which the script is written, for an application, such as for a database application, are designed to operate and execute in a source environment. To “copy” or “clone” the application to another environment requires knowledge of the installation scripts of the application, including any updates, corrections, fixes, patchsets or configuration changes, for example. Features of the present invention provide for storage of the original installation scripts and the updating thereof, so that when a need or desire for cloning occurs, the very same original installation scripts, together with any updates or modifications thereof, can be executed in the new, target environment automatically. Although the “cloning” process described herein will generally be described in terms of a database home/software, it will be understood that the present invention can be applied to any software product or system that is capable of being cloned.

As shown in FIG. 1, in one embodiment a system 100 incorporating features of the present invention includes a user computer system 102 and a database home 104. The source installation 108 for the original database home 104 can comprise for example, an installation CD or other magnetic media that is used to install the original database home. In alternative embodiments any suitable means can be used to provide the original installation of the database home 104, including, but not limited to, for example a download from an Internet (WWW) site. During the installation of the database home 104, the installation scripts 106 used to install the database home 104 are stored in the database home 104. For example, the ORACLE UNIVERSAL INSTALLER generally always installs the associated installation scripts in the home in a file system directory under the same file system directory that contains the product software. In alternate embodiments, any suitable program software installation system or process for saving installations scripts that allows them to be transferred can be utilized. The system and methods of the disclosed embodiments can be applied to any system or product that supports home cloning, which is generally indicated by an attribute of the installation software itself, and is being installed into a new home or an existing clonable home. An existing clonable home is generally one that contains only clonable products.

When a user desires to “clone” the original database home 104 to a target location 120, the user can activate a “clone mode” 110 on the computer system 102 in order to execute the installation scripts 106 from the home location at the target location 120 to create a “clone” of the original database home 104 without the need for manual configuration updates. Copying of the database home 104 to the target location 120 generally occurs, with the installation scripts 106 being transferred or copied from the home location 104 to the target location 120. Since the copied installation scripts include all patch sets and modifications that might have been required in the home location 104, once cloning occurs, the target location 120 is essentially a replica of the home location 104.

In one embodiment, the user may utilize a product such as the Oracle® Universal Installer (“OUI”) to clone the database installation from the home location to the target location. The OUI can include a “clone” feature, that when activated automatically executes the copied and stored installation scripts in the target location.

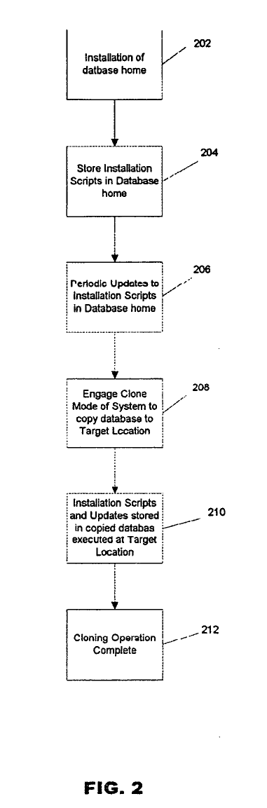

Referring to FIG. 2, one embodiment of a method incorporating features of the present invention is illustrated. During the installation 202 of a database home, the installation scripts that are used to install this instance of the database home are stored 204 inside the database home. Should the database home be modified or updated in any way, for example to apply a patchset, the installation scripts stored inside the database home are automatically updated 206 as well. When the database home is copied 208 to another location, or cloned, the installation scripts stored inside the database home, including any and all updates and modifications, are also copied to the target location. Once the database home is copied 208 to the target location, the installation scripts now stored in the target location can be located and executed 210 to complete 212 the installation of the cloned database home. In one embodiment, this comprises using an installation program, such as for example, the Oracle® Universal Installer, to activate a clone mode. The location and name of the home to be cloned are automatically passed to the installer. The installer locates the install action scripts inside the home and plays them back in a special mode, which can be called the clone mode. During the cloning session the installer can recognize actions that need to be replayed from the ones that should be skipped. For example, in one embodiment the registry keys that were created during the installation time are recreated. All file copying actions are skipped since the files already exist inside the home.

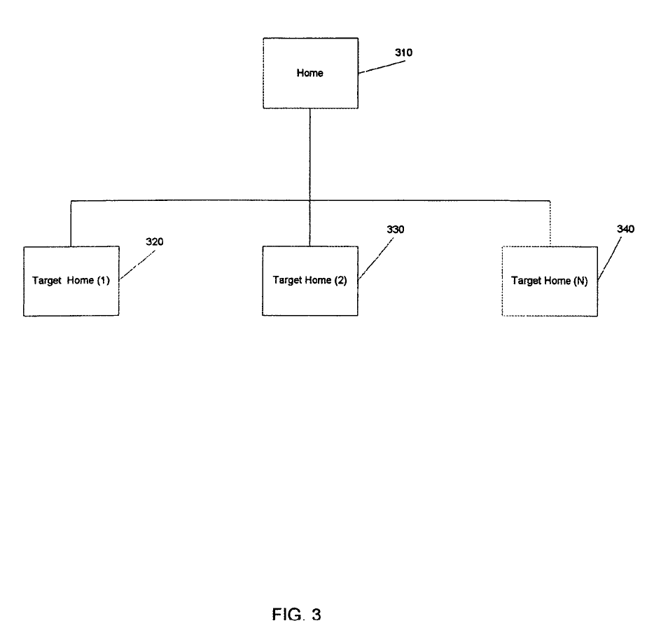

In one embodiment, referring to FIG. 3. the present invention can be applied to grid computing in order to add “nodes” 320-340 to a grid 300 without the need to go through the process of installing, patching and configuring on each node 320-340. “Grid computing” generally refers to a system or network of many computing devices coupled or connected to a common gateway or network. The ease of deployment of software in a grid computing system is important, as is the ability to expand the size of the grid by adding more nodes to the grid. The addition of nodes to a grid provides the ability to increase capacity, performance and fault tolerance. However, if the process to add a “node” to a grid requires manually determining what installation scripts are required, locating or copying the installation scripts, applying patchsets, and manually adjusting the configuration, there is at least a perceived complexity in the deployment and maintenance of nodes and software. The present invention allows a node to be added to a grid in an automated and simplified process.

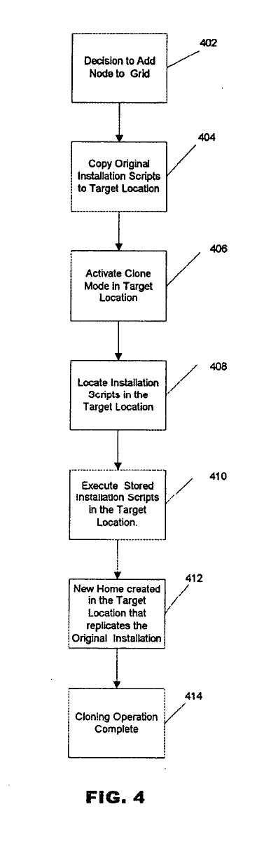

Referring to FIGS. 3 and 4, a decision 402 is made to add a node to a computing grid. Within the computing grid 300 of FIG. 3, there is a configured installation 310 that is desired to be cloned. The installation 310 is generally one that has been tested and proven to be reliable. It is a feature of the present invention to be able to clone a “gold” installation that has already been configured and tested.

The desired home 310 is at some point copied 404 to at least one target location 320. Previously, during the original installation of the home 310 in the source location, the installation scripts were stored in the home 310. These installation scripts are now copied to the target location 320 when the home 310 is copied 404. The clone mode is activated 406 and the installation scripts are then located 408 at the target location 320 and are played or executed 410 in the target location 320. Thus, a new home at the target location 320 is created 412 that replicates the original home installation 310. Since the home 310 is likely to have been configured and tested, the operator can easily add known configuration nodes to the grid 300 with a degree of confidence and without the need for manual configuration of the software installation scripts.

In one embodiment, the original home installation could be cloned to another environment 330 or 340. Alternatively, after the original home 310 is cloned in target home 320, the target home 320 can be modified as desired and then the modified target home 320 cloned to target home 330.

Since the original installation scripts are saved in the home, all a user needs to know is the command used for cloning. The command for cloning can be irrespective of the contents of the home, which contrasts with present approaches that require a user to know exactly what is installed in a home, how it is configured and how it has been modified to be able to clone it. Present practices for “cloning” a database installation require reverse engineering the database installation, and each such process is installation or version specific. The present invention can be applied more generically and is not installation or product specific. Since the installation scripts are stored in original home at the time of the original installation from the installation media and copied to the new home, execution of the install scripts in the new home upon activation of the clone function replicates the original, and modified or updated if applicable, home in the new environment. Thus, in the present invention, there is no need to reverse engineer the original product or installation.

In one embodiment, the clone command could be for example an icon on a display screen that is activated to initiate or execute the cloning of an application.

The clone mode installation replicates the original installation except that the software for the application is already present. The application software has been patched, configured and modified if needed, and the process can be fully automated. Any extra steps of locating installation scripts, configuring the scripts for the target environment, upgrading or modifying the scripts are eliminated.

By essentially replicating an existing application, a known configuration can be easily and automatically cloned for developmental testing, without affecting the known or original application.

For example, in one embodiment it is possible to use the present invention to clone an application from an original or prior installation to a development station in order to test a configuration change or modification, without disturbing the original or prior database home. Once the application or original home is cloned, a patch, or configuration change in the new environment can be applied and tested. This allows the patch to be tested on a known configuration without the need to have to manually go in and examine what files would need to be transferred and changed.

By integrating cloning with the installation of an application, the present invention generally provides a uniform well defined approach that allows all Oracle™ products to be clonable out of the box. All the user needs to know to clone a home is the command used for cloning irrespective of the contents of the home. This is in contrast with the very involved old approach where the user needs to know exactly what is installed in a home and how it is configured to be able to clone it.

In an embodiment of the present invention where cloning is performed using Oracle® Universal Installer, the Oracle® Universal Installer inventory gets properly updated in the target home. This means that the cloned product can eventually be patched, upgraded, deinstalled, or queried by other applications that access the OUI inventory.

Significantly, the cloning operation of a database home reduces the amount of support calls since the cloning process is now built in the product. Customers do not need to hack into the product to get it to work in the target environment.

The status of the cloned home is known and pre-defined since the cloning always happens through the same process. This is in contrast with the old approach where each customer has a different set of cloning scripts and processes, resulting in a different cloned home.

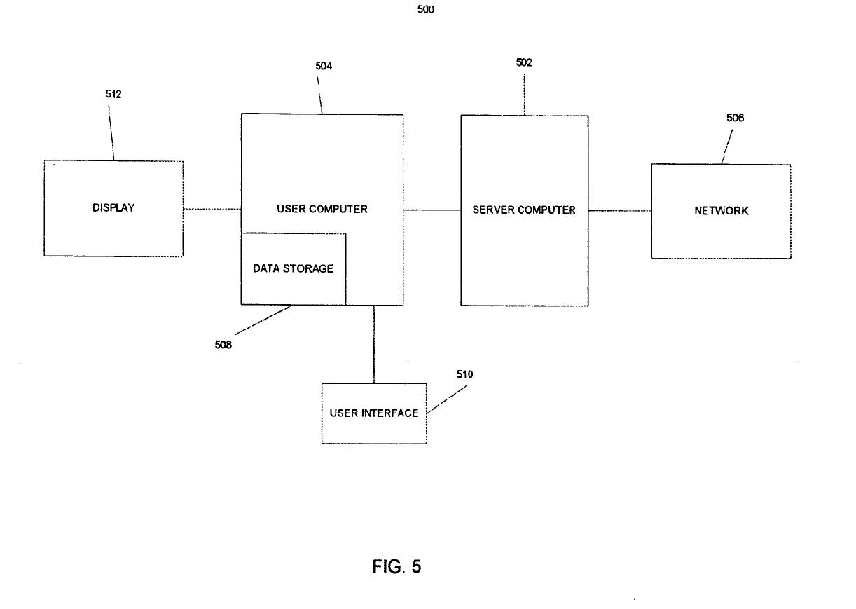

The present invention may also include software and computer programs incorporating the process steps and instructions described above that are executed in different computers. In the preferred embodiment, the computers are connected to the Internet. FIG. 5 is a block diagram of one embodiment of a typical apparatus 500 incorporating features of the present invention that may be used to practice the present invention. As shown, a computer system 502 may be linked to another computer system 504, such that the computers 502 and 504 are capable of sending information to each other and receiving information from each other. In one embodiment, computer system 502 could include a server computer adapted to communicate with a network 506, such as for example, the Internet. Computer systems 502 and 504 can be linked together in any conventional manner including a modem, hard wire connection, or fiber optic link. Generally, information can be made available to both computer systems 502 and 504 using a communication protocol typically sent over a communication channel or through a dial-up connection on ISDN line. Computers 502 and 504 are generally adapted to utilize program storage devices embodying machine readable program source code which is adapted to cause the computers 502 and 504 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 502 and 504 may also include a microprocessor for executing stored programs. Computer 502 may include a data storage device 508 on its program storage device for the storage of information and data. The computer program or software incorporating the processes and method steps incorporating features of the present invention may be stored in one or more computers 502 and 504 on an otherwise conventional program storage device. In one embodiment, computers 502 and 504 may include a user interface 510, and a display interface 512 from which features of the present invention can be accessed. The user interface 508 and the display interface 512 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method of cloning a clonable system from a source environment to a target environment comprising:
storing original installation scripts, used to install a home in the source environment, in the home;
locating the original installation scripts inside the home that has been copied into the target environment and executing those installation scripts to replicate the home in the target environment.

2. The method of claim 1 further comprising, after the home is copied to the target location, of activating a clone mode in the target location and passing a name and location of a home to be cloned to the clone mode.

3. The method of claim 1 further comprising updating the installation scripts in the database each time the home is modified.

4. The method of claim 1 further comprising, after locating the installation scripts inside the home in the target environment, of determining which installation scripts need to be executed and which installation scripts should be skipped.

5. The method of claim 1 wherein the step of executing the installation scripts further comprises recreating registry keys created during an original installation of the home and skipping all file copying actions.

6. The method of claim 1 further comprising, after storing installation scripts used to install a home in the source environment in the home, marking some installation scripts as installation scripts to be performed only when executing the installation scripts in an installation mode or in a clone mode.

7. The method of claim 1 wherein the home is a database home.

8. A method of facilitating adding a node to a computer grid comprising:
locating installation scripts from a home copied to at least one target environment, the installation scripts being those original installation scripts used to install the home together with any updates or modifications thereto; and
executing the installation scripts inside the target environment to automatically install the home in the target environment.

9. The method of claim 8 wherein the home is a database home.

10. A computer program product comprising:
a computer useable medium having computer readable code means embodied therein for causing a computer to automatically replicate a clonable system in a target environment that is different from a home environment, the computer readable code means in the computer program product comprising:
computer readable program code means for causing a computer to store original installation scripts used during the installation of the home, and any updates or modifications to the home, in the home environment;
computer readable program code means for causing a computer to locate the original installations scripts and any updates or modifications in the target environment after the home is copied from the home environment to the target environment, the original installation scripts and any updates or modifications being transferred to the target environment when the home is copied to the target environment; and
computer readable program code means for causing a computer to execute the original installation scripts and any updates or modification in the target environment to complete cloning of the home in the target environment.

11. An article of manufacture comprising:
a computer useable medium having computer readable program code means embodied therein for causing a computer to replicate a clonable system from a home environment in a target environment, the computer readable code means in the article of manufacture comprising:
computer readable program code means for causing a computer to store, in the home environment, original installation scripts used during the installation of the system, and any updates or modifications to the home;
computer readable program code means for causing a computer to locate, in the target environment, the original installations scripts and any updates or modifications, the original installations scripts and any updates or modifications having been copied from the home environment to the target environment; and
computer readable program code means for causing a computer to execute, in the target environment, the original installation scripts and any updates or modifications to replicate the system in the target environment.
